(19) United States
(12) Patent Application Publication
(10) Pub. No.: US 2020/0379742 A1
(43) Pub. Date: Dec. 3, 2020

(54) VALIDATION OF CONFIGURATIONS OF FACTORY INSTALLATIONS

(71) Applicant: VMware, Inc., Palo Alto, CA (US)

(72) Inventors: Neeraj Saluja, Round Rock, TX (US); Brooks Peppin, Colorado Springs, CO (US); Akhil Parasa, Cedar Park, TX (US); Jose A. Alvarez Ramos, Round Rock, TX (US); Rob Schlotman, Cumming, GA (US)

(21) Appl. No.: 16/427,481

(22) Filed: May 31, 2019

(51) Int. Cl. G06F 8/61; G06F 9/455

(52) U.S. Cl. CPC G06F 8/63; G06F 2009/45583; G06F 9/45558

(57) ABSTRACT

Disclosed are various approaches for validating factory provisioning of computing devices with a virtual machine. A package file is unpacked, the package file containing: at least one application to be installed on the virtual machine, and a configuration file containing at least one setting for an operating system installed on the virtual machine or the at least one application and at least one respective value for the at least one setting. Then at least one application is installed on the virtual machine. Installation of the application is confirmed. Then the operating system is configured based on the configuration file, and the configuration of the operating system is confirmed. The results are then rendered in a user interface to indicate whether installation of the applications and configuration of the operating system was successful.

### BACKGROUND

Original equipment manufacturers (OEMs) of computing devices often permit customers to specify additional applications to be installed at the factory. For example, a laptop or desktop manufacturer can allow a customer to request that a copy of an office suite or photo-editing software be installed at the factory prior to shipping the device to the customer. OEMs can allow larger, enterprise customers, to provide a disk image to be installed on computing devices procured by the enterprise.

However, changes to the disk image supplied by the enterprise customer can contain errors that are not detectable until the disk image is applied to a new computing device at the factory. To identify, diagnose, and debug errors in the disk image, an enterprise customer can have to provide an image to the factory, and then wait a few days or a few weeks for the image to be installed on a computing device and an error to be reported. The enterprise can then create an updated image, send it to the factory, and wait to learn if installation of the updated image was successful. If multiple rounds of debugging are necessary, then deployment of an image can be delayed by significant periods of time measured in weeks or even months.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a networked environment according to various embodiments of the present disclosure.

FIG. 3 is a flowchart illustrating one example of functionality implemented as portions of an application executed in a computing environment in the networked environment of FIG. 2 according to various embodiments of the present disclosure.

### DETAILED DESCRIPTION

Disclosed are various approaches for validating configurations for computing devices before their deployment to an OEM for use in configuring new computing devices. Installation of client applications can be automatically tested using a utility operating in a virtual machine. Likewise, configuration of client applications or the client operating system can be tested using the utility operating in the virtual machine. In the following discussion, a general description of the system and its components is provided, followed by a discussion of the operation of the same.

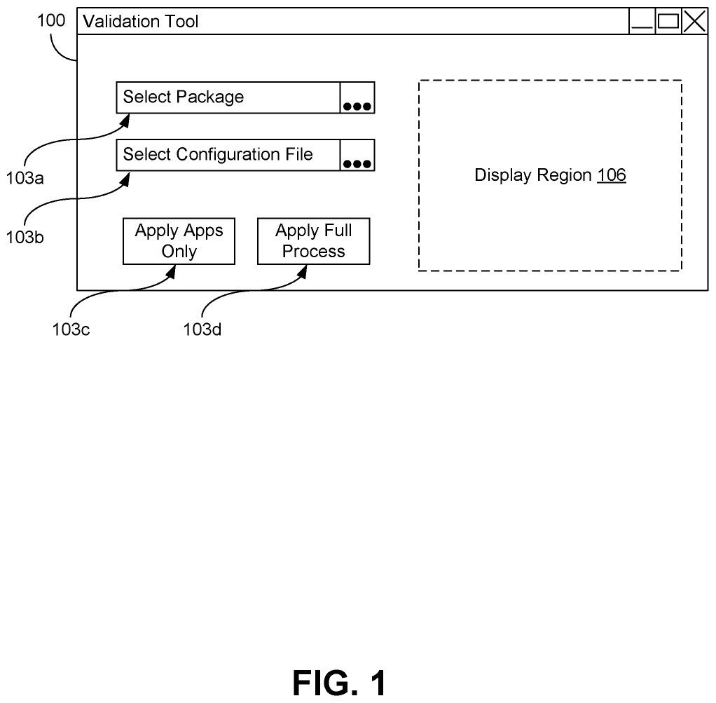

As illustrated in FIG. 1, a user interface 100 of a utility for automatically testing the installation of client applications or the configuration of the operating system is depicted. The user interface 100 includes a number of user interface elements 103a, 103b, 103c, and 103d (collectively the “user interface elements), which allow a user to configure and execute the automated test. For example, a user might manipulate a first user interface element 103a to select a package (e.g., a MICROSOFT® provisioning package (PPKG) file) for testing prior to providing the package to the OEM. As another example, a user might manipulate a second user interface element 103b to select a configuration file for testing prior to providing the configuration file to the OEM. To execute the automated test, the user may manipulate additional user interface elements 103, such as user interface elements 103c and 103d. For example, a user might manipulate user interface element 103c to only test the installation of client applications. However, a user might manipulate user interface element 103d to test the installation of client applications included in the package and the configuration of settings according to a configuration file. The user interface 100 can also include a display region 106, within which instructions for how to use the utility or the results of the testing can be rendered.

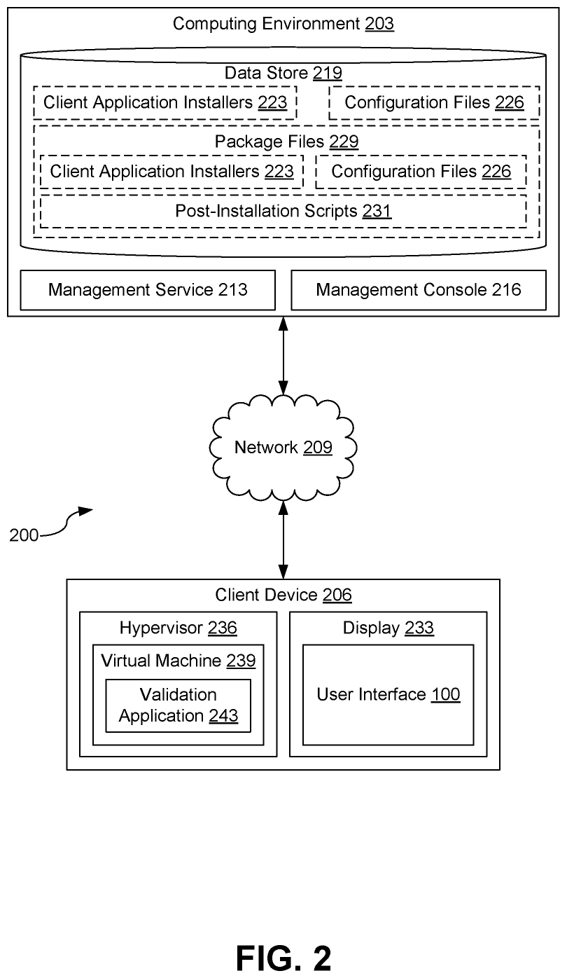

With reference to FIG. 2, shown is a networked environment 200 according to various embodiments. The networked environment 200 includes a computing environment 203 and potentially a client device 206, which can be in data communication with each other via a network 109. The network 109 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include, for example, a server computer or any other system providing computing capability. Alternatively, the computing environment 203 can employ a plurality of computing devices that can be arranged, for example, in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203 according to various embodiments. The components executed on the computing environment 203 can include the management service 213, the management console 216, as well as other applications, services, processes, systems, engines, or functionality not discussed in detail herein.

Also, various data is stored in a data store 219 that is accessible to the computing environment 203. The data store 219 can be representative of a plurality of data stores 219, which can include relational databases, object-oriented databases, hierarchical databases, hash tables or similar key-value data stores, as well as other data storage applications or data structures. The data stored in the data store 219 is associated with the operation of the various applications or functional entities described below. This data can include various client application installers 223, configuration files 226, package files 229, and potentially other data.

The client application installers 223 can represent applications that, when executed, install a respective client application on a computing device and configure the computing device to be able to execute the client application. One example of a client application installer is a Windows Installer package (e.g., “msi” files).

The configuration files 226 can represent files that allow for unattended configuration of a client application by a client application installer 223 or unattended configuration of an operating system that has been installed on a computing device. For example, when a version of the MICROSOFT WINDOWS® operating system is installed on a computing device, the user is often asked to answer a series of questions in order to finish configuring and personalizing the computing device. Answering these questions can be time-intensive, so the use of a configuration file 226 containing the answers to automate the answering of these configuration questions can allow for an operating system to be installed and configured more efficiently. An example of a configuration file 226 is the “unattend.xml” file used by MICROSOFT WINDOWS to automate the configuration of the WINDOWS operating system during installation and during the first boot sequence after installation, which is often referred to as the out of box experience (“OOBE”).

A package file 229 can represent a collection or archive of client application installers 223 and configuration files 226 bundled together in a single file. A package file 229 can also include one or more post-installation scripts 231, which can verify that a client application installer 223 correctly installed a client application or that values in a configuration file 226 were correctly applied. One example of a package file 229 is a MICROSOFT provisioning package (PPKG) file.

The management service 213 can manage data stored in the data store 219 and respond to or implement commands received from the management console 216. For example, the management service can create package files 229 and add client application installers 223 or configuration files 226 to the package file 229 in response to a command received from the management console 216. The management service 213 can also save or store new or updated client application installers 223 and configuration files 226 that are uploaded through the management console 216.

The management console 216 can provide an administrative interface for interacting with the management service 213. To provide the administrative interface, the management console 216 can include a web page or web application provided by a web server hosted in the computing environment 203. A user can interact with individual web pages, or portions of a web page, to configure or create package files 229. This can include adding one or more client application installers 223 to a package file 229 or one or more configuration files 226 to the package file 229. Similarly, a user can also interact with individual web pages, or portions of a web page, to add new or client application installers 223 and new configuration files 226 to the data store 213 or to update existing client application installers 223 and configuration files 226 already present in the data store 213.

The client device 206 is representative of a plurality of client devices that can be coupled to the network 209. The client device 206 can include, for example, a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 233, such as liquid crystal displays (LCDs), gas plasma-based flat panel displays, organic light emitting diode (OLED) displays, electrophoretic ink (“E-ink”) displays, projectors, or other types of display devices. In some instances, the display 233 can be a component of the client device 206 or can be connected to the client device 206 through a wired or wireless connection.

The client device 206 can execute various applications such as a hypervisor 236 or other applications. The hypervisor 236 can manage the hardware resources of the client device 206 and share the hardware resources of the client device 206 among multiple virtual machines 239. As a result, the hypervisor 236 can allow for multiple virtual machines 239 to be executed or hosted by the same client device 206, while remaining isolated from each other. Many hypervisors 239 can use virtualization-specific features provided by the processor of the client device 206 in order to efficiently share and manage the hardware resources of the client device 206 among the hosted virtual machines 239. Examples of hypervisors include the VMware ESX™ hypervisor, the VMware ESXi™ hypervisor, the VMWARE WORKSTATION™ hypervisor, the MICROSOFT HYPER-V® hypervisor, the XEN hypervisor, and ORACLE VIRTUALBOX® hypervisor.

The virtual machine 239 can represent a software emulation of a computer system. Accordingly, a virtual machine 239 can provide the functionality of a physical computer sufficient to allow for installation and execution of an entire operating system and any applications that are supported or executable by the operating system. Accordingly, a virtual machine 239 can be used as a substitute for a physical machine.

The validation application 243 can test the whether a selected package file 229 or configuration file 226 will be successfully applied to computing device that is emulated or replicated by the virtual machine 239.

Although the hypervisor 236 is depicted as being executed by the client device 206, the hypervisor 236 can be hosted by one or more servers in the computing environment 203. In these implementations, the hypervisor 236 can host a virtual machine 239 in the computing environment 203 and the user can connect to the virtual machine 239 using remote access software, such as a remote desktop protocol (RDP) or virtual network computing (VNC) client. In these implementations, the virtual machine 239 would be hosted by the computing environment, and the validation application 243 would be executed by the virtual machine 239 in the computing environment 203, but the user interface 100 would still be rendered on the display 233 of the client device 206 through the RDP or VNC client.

Next, a general description of the operation of the various components of the networked environment 200 is provided. Although the general description provides one example of the operation of the various components of the networked environment 200, the components can interact in other ways according to the requirements of specific implementations.

To begin, a user can create a package file 229 for deployment to an OEM for configuring computing devices manufactured or assembled by the OEM. For example, an enterprise can wish to have a package file 229 created to configure laptop and desktop computers purchased from the OEM in a specific manner (e.g., to have a set of commonly used applications installed and pre-configured on each computing device). Accordingly, the user can select one or more client application installers 223 to be added to a package file 229 using the management console 216. The user can also create a configuration file 226 using the management console 216 to manage the installation of the client application installers 223 or configure the operating system installed on the computing device by the OEM. The user can then add the configuration file 226 to the package file 229 using the management console 216.

Once the user has selected all of the client application installers 223 and configuration files 226 to be added to the package file 229, the management service 213 can create or otherwise export the package file 229. The package file 229 can then be saved to the data store 219 until it is retrieved for use at a later time (e.g., by the validation application 243 for testing or by the OEM for installation on new computing devices).

Prior to providing the newly created package file 229 to the OEM, the user can test the package file 229 in order to verify that the package file 229, when applied to a new computing device, correctly installs each client application and configures the applications and operating system correctly. Accordingly, the user can instantiate a virtual machine 239 that matches the state of a newly configured or assembled computing device at the time the OEM would apply the package file 229. The user can then execute the validation application 243 within the virtual machine 239. The validation application 243 can retrieve the package file 229 or the configuration file 226, if separately specified. The validation application 243 can then unpack the package file 229, execute each client installer application 223 contained within the package file 229, and configure the applications and operating system according to the parameters set forth in the configuration file 226.

The validation application 243 can monitor and report the progress of each client application installer 223 and whether each setting specified in the configuration file 226 was configured correctly. For example, the validation application 243 can check to see if a client application installer 223 exited with an error, or completed installation successfully. Likewise, the validation application 243 can independent check to see if the value for each setting specified in the configuration file 226 matches the value specified in the configuration file 226. If no errors are detected, the validation application 243 can indicate within the user interface 100 that the package file 229 or the configuration file 226 can be provided to the OEM. If any errors are detected, the validation application 243 can instead indicate within the user interface 100 the type of error and the cause of the error (e.g., identify the client application installer 223 that generated the error and the type of error generated).

In some implementations, the validation application 243 can be executed after first placing the operating system of the virtual machine into a configuration mode. This can be done to match the circumstances under which the package file 239 would be applied by an OEM at the factory to a newly manufactured or imaged computing device in order to more accurately test the validation application 243. In general, after a generic image of an operating system is installed on a computing device by the OEM, the OEM will often boot the operating system into a configuration mode in order to install additional applications requested by a customer or configure the computing device in a manner requested by the customer.

An example of such a configuration mode is the WINDOWS audit mode provided by versions of the MICROSOFT WINDOWS operating system. The WINDOWS audit mode is a mode provided by WINDOWS to allow administrative users to customize a computing device that already has WINDOWS installed on it. The WINDOWS audit mode allows for a user to install applications and device drivers, configure the WINDOWS environment, and perform other administrative functions, without requiring access to the credentials of an organization's system administrator account. For example, a generic WINDOWS image can be installed to a computing device. When booted normally, credentials for an administrator account can be required in order to install applications or configure certain system settings. When booted in audit mode, however, applications can be installed and system settings configured without access to such an account.

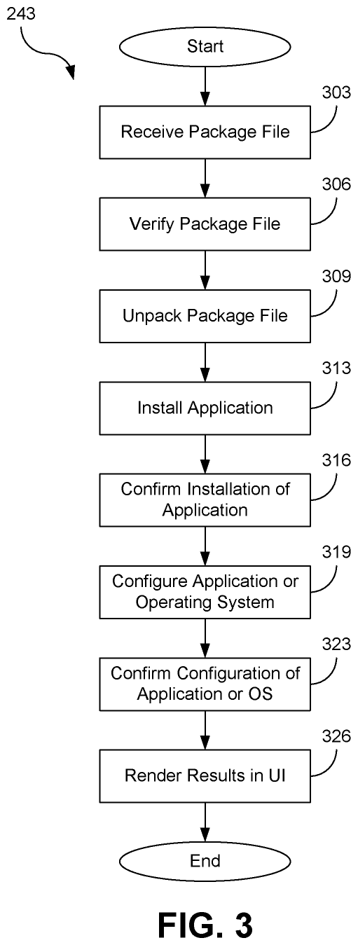

Referring next to FIG. 3, shown is a flowchart that provides one example of the operation of a portion of the validation application 243 according to various embodiments. It is understood that the flowchart of FIG. 3 provides merely an example of the many different types of functional arrangements that can be employed to implement the operation of the portion of the validation application 243 as described herein. As an alternative, the flowchart of FIG. 3 can be viewed as depicting an example of elements of a method implemented in the computing environment 203 (FIG. 2) according to one or more embodiments.

Beginning with step 303, the validation application 243 can retrieve a previously created package file 229 from a data store 219. For example, the package file 229 and its location can have been specified using a user interface element 103 within the user interface 100 of the validation application. The validation application 243 could then retrieve the identified package file 229 from the data store 219.

Next at step 306, the validation application 243 can verify the package file 229. For example, the package file 229 can contain a cryptographic signature generated using a private encryption key from a public-private key-pair of the management service 113. The cryptographic signature could be verified using the respective public-key of the management service 113 to determine whether the package file 229 was generated by the management service 113 or an untrusted entity. For instance, malicious third-parties could attempt to infect a machine image by replacing a valid package file 229 with a compromised package file 229.

Then at step 309, the validation application 243 can unpack or otherwise extract the contents of the package file 229. For example, the validation application 243 could decompress the package file 229 if it were compressed. The validation application 243 could then access the contents of the package file 229, such as individual client application installers 223 and configuration file(s) 226. In some instances, the validation application 243 might temporarily copy the client application installers 223 and configuration file(s) 226 to a temporary location on a disk of the virtual machine 239.

In some instances, the validation application 243 can also measure the amount of time required to unpack the package file 229 at step 309. For example, the validation application 243 can execute a timer concurrently with performing step 309. The amount of time can be tracked in order to confirm that large package files 229 can be processed (e.g., decompressed or unpacked) within a predefined period of time (e.g., a maximum amount of time that the OEM can allot for customizing the configuration of a computing device at the factory).

Moving to step 313, the validation application 243 can execute each client application installer 223 that was included in the package file 229 to install a respective client application. When executing a client application installer 223, the validation application 243 can provide arguments to the client application installer 223 that are specified in a configuration file 226 included in the package file 229.

Next at step 316, the validation application 243 can confirm installation of each client application. Confirmation can be implemented in several ways. Any one or more of these approaches can be used alone or in combination.

For example, the validation application 243 could monitor the progress of a client application installer 223. If the client application installer 243 exits with no error codes, then the validation application 243 can conclude that the application installed successfully. Likewise, if the client application installer 243 exits with an error code, then the validation application 243 can conclude that the application failed to install successfully.

As another example, one or more post-installation scripts could be included in the package file 229. A post-installation script could be configured to check to see if the client application installer 223 installed the application in the correct locations, installed the correct version, set configuration settings to the correct values, and perform other post-installation tasks. If the post-installation script executes successfully, the validation application 243 could determine that the client application installer 223 successfully installed the client application. Likewise, if the post-installation script returned one or more error messages or values, the validation application 2343 could determine that the client application installer 223 failed to install the client application successfully.

In some instances, the validation application 243 can also measure the amount of time required to execute the client application installers 223 at step 313. For example, the validation application 243 can execute a timer concurrently with performing step 313. The amount of time can be tracked in order to confirm that the installation of the client applications can occur within a predefined period of time (e.g., a maximum amount of time that the OEM can allot for customizing the configuration of a computing device at the factory).

Then at step 319, the validation application 243 can configure the operating system or the installed client applications according to the configuration file(s) 226 that were included in the package file 229. For example, as part of the operating system configuration process, a configuration file 226 could be supplied as an argument to the operating system installer or setup program (e.g., the “unattend.xml” file could be provided as an argument to the “sysprep.exe” tool included with installations of MICROSOFT WINDOWS during the configuration phase). Similarly, the validation application 243 could invoke an installed application and provide a configuration file 226 as an argument in order to perform post-installation configuration of the client application.

In some instances, the validation application 243 can also measure the amount of time required to configure the operating system or the installed client applications at step 319. For example, the validation application 243 can execute a timer concurrently with performing step 319. The amount of time can be tracked in order to confirm that the installation of the client applications can occur within a predefined period of time (e.g., a maximum amount of time that the OEM can allot for customizing the configuration of a computing device at the factory).

Proceeding to step 323, the validation application 243 can confirm that the installed client applications and the operating system were configured in the manner specified by the configuration file(s) 226. As an example, the validation application 243 could compare the values of operating system settings to values specified in a configuration file 226. For instance, the validation application 243 could use system calls to compare registry key values in the WINDOWS registry to values for respective settings specified in the configuration file 226. If a mismatch were detected, then the validation application 243 could determine that an error occurred, while a match would indicate that the setting was set to the correct value. In a similar example, the validation application 243 could compare the configuration of the installed client application to the values specified in a configuration file 226 included in the package file 229. If the values matched, then the validation application 243 could determine that the settings for the installed client application were correct, while a mismatch could indicate that a setting specified in the configuration file 226 was not correctly applied to the client application during installation.

Finally, at step 326, the validation application 243 can render the results of steps 316 and 323 within the user interface 100 of the validation application 243. For example, any errors that occurred when executing the client application installers 223 or configuring installed client applicants or the operating system can be displayed within the display region 106. As another example, if no errors occurred, this information can be presented in the display region 106. In those implementations that measured the amount of time required to perform one or more of steps 309, 313, and 319, the measured times can be displayed as well.

The flowchart of FIG. 3 shows the functionality and operation of an implementation of portions of the validation application 243. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor PROCESSOR NUMBER in a computer system or other system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowchart of FIG. 3 shows a specific order of execution, it is understood that the order of execution can differ from that which is depicted. For example, the order of execution of two or more blocks can be scrambled relative to the order shown. Also, two or more blocks shown in succession in FIG. 3 can be executed concurrently or with partial concurrence. Further, in some embodiments, one or more of the blocks shown in FIG. 3 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the validation application 243, that includes software or code can be embodied in any non-transitory computer-readable medium for use by or in connection with an instruction execution system such as, for example, a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the validation application 243, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system for validating factory provisioning of computing devices, comprising:
a computing device comprising a processor and a memory;
a virtual machine stored in the memory, the virtual machine having an operating system installed in the virtual machine, the operating system being in a factory state that matches a factory image of the operating system;
machine-readable instructions stored in the memory allocated to the virtual machine that, when executed by the processor, cause the virtual machine to at least:
unpack a package file containing:
at least one application to be installed on the virtual machine, and
a configuration file containing at least one setting for the operating system or the at least one application and at least one respective value for the at least one setting;
install the at least one application on the virtual machine;
confirm installation of the at least one application on the virtual machine;
configure the operating system based on the at least one respective value for the at least one setting;
confirm that configuration of the operating system matches the configuration file; and
render in a user interface an indication that installation of the at least one application and configuration of the operating system was successful.

2. The system of claim 1, wherein the machine-readable instructions, when executed by the processor, further cause the virtual machine to at least verify that the package file is a valid package file.

3. The system of claim 1, wherein the machine-readable instructions that cause the virtual machine to confirm installation of the at least one application on the virtual machine further cause the virtual machine to at least:
execute a post-installation script in response to installation of the at least one application on the virtual machine; and
analyze output generated by the post-installation script to confirm installation.

4. The system of claim 1, wherein:
the indication is a first indication; and
the machine-readable instructions, when executed by the processor, further cause the virtual machine to at least:
measure an amount of time spent unpacking the package file; and
render in the user interface a second indication that comprises the amount of time spent unpacking the package file.

5. The system of claim 1, wherein:
the indication is a first indication; and
the machine-readable instructions, when executed by the processor, further cause the virtual machine to at least:
measure an amount of time spent installing the at least one application; and
render in the user interface a second indication that comprises the amount of time spent installing the at least one application.

6. The system of claim 1, wherein:
the indication is a first indication; and
the machine-readable instructions, when executed by the processor, further cause the virtual machine to at least:
measure an amount of time spent configuring the operating system; and
render in the user interface a second indication that comprises the amount of time spent configuring the operating system.

7. The system of claim 1, wherein the machine-readable instructions, when executed by the processor, further cause the virtual machine to at least render in the user interface an interface element that allows a user to select the package file.

8. A method for validating factory provisioning of computing devices, comprising:
unpacking, within a virtual machine, a package file containing:
at least one application to be installed on the virtual machine, and
a configuration file containing at least one setting for an operating system installed on the virtual machine or the at least one application and at least one respective value for the at least one setting;
installing, within the virtual machine, the at least one application on the virtual machine;
confirming, within the virtual machine, installation of the at least one application on the virtual machine;
configuring, within the virtual machine, the operating system based on the at least one respective value for the at least one setting;
confirming, within the virtual machine, that configuration of the operating system matches the configuration file; and
rendering, within the virtual machine, in a user interface an indication that installation of the at least one application and configuration of the operating system was successful.

9. The method of claim 8, further comprising verifying that the package file is a valid package file.

10. The method of claim 8, wherein confirming installation of the at least one application further comprises:
executing, within the virtual machine, a post-installation script in response to installation of the at least one application on the virtual machine; and
analyzing, within the virtual machine, output generated by the post-installation script to confirm installation.

11. The method of claim 8, wherein:
the indication is a first indication; and
the method further comprises:
measuring, within the virtual machine, an amount of time spent unpacking the package file; and
rendering, with the virtual machine, in the user interface a second indication comprising the amount of time spent unpacking the package file.

12. The method of claim 8, wherein:
the indication is a first indication; and
the method further comprises:
measuring, within the virtual machine, an amount of time spent installing the at least one application; and
rendering, with the virtual machine, in the user interface a second indication that comprises the amount of time spent installing the at least one application.

13. The method of claim 8, wherein:
the indication is a first indication; and
the method further comprises:
measuring, within the virtual machine, an amount of time spent configuring the operating system of the virtual machine; and
rendering, with the virtual machine, in the user interface a second indication that comprises the amount of time spent configuring the operating system.

14. The method of claim 8, further comprising rendering, with the virtual machine, an interface element in the user interface that allows a user to select the package file.

15. A non-transitory, computer-readable medium comprising machine-readable instructions for validating factory provisioning of computing devices, wherein the machine-readable instructions, when executed by a processor, cause a virtual machine hosted by a computing device to at least:
unpack a package file containing:
at least one application to be installed on the virtual machine, and
a configuration file containing at least one setting for an operating system executing on the virtual machine or the at least one application and at least one respective value for the at least one setting;
install the at least one application on the virtual machine;
confirm installation of the at least one application on the virtual machine;
configure the operating system based on the at least one respective value for the at least one setting;
confirm that configuration of the operating system matches the configuration file; and
render in a user interface an indication that installation of the at least one application and configuration of the operating system was successful.

16. The non-transitory, computer-readable medium of claim 15, wherein the machine-readable instructions, when executed by the processor, further cause the virtual machine to at least verify that the package file is a valid package file.

17. The non-transitory, computer-readable medium of claim 15, wherein the machine-readable instructions that cause the virtual machine to confirm installation of the at least one application on the virtual machine further cause the virtual machine to at least:
execute a post-installation script in response to installation of the at least one application on the virtual machine; and
analyze output generated by the post-installation script to confirm installation.

18. The non-transitory, computer-readable medium of claim 15, wherein:
the indication is a first indication; and
the machine-readable instructions, when executed by the processor, further cause the virtual machine to at least:
measure an amount of time spent unpacking the package file; and
render in the user interface a second indication that comprises the amount of time spent unpacking the package file.

19. The non-transitory, computer-readable medium of claim 15, wherein:
the indication is a first indication; and
the machine-readable instructions, when executed by the processor, further cause the virtual machine to at least:
measure an amount of time spent installing the at least one application; and
render in the user interface a second indication that comprises the amount of time spent installing the at least one application.

20. The non-transitory, computer-readable medium of claim 15, wherein:
the indication is a first indication; and
the machine-readable instructions, when executed by the processor, further cause the virtual machine to at least:
measure an amount of time spent configuring the operating system; and
render in the user interface a second indication that comprises the amount of time spent configuring the operating system.
